(19) United States
(12) Patent Application Publication
(10) Pub. No.: US 2014/0009418 A1
(43) Pub. Date: Jan. 9, 2014

(54) OPERATION DISPLAY DEVICE, OPERATION DISPLAY METHOD AND TANGIBLE COMPUTER-READABLE RECORDING MEDIUM

(71) Applicant: KONICA MINOLTA, INC., Chiyoda-ku (JP)

(72) Inventor: Yasuaki SUGIMOTO, Hachioji-shi (JP)

(21) Appl. No.: 13/934,612

(22) Filed: Jul. 3, 2013

(30) Foreign Application Priority Data
Jul. 9, 2012 (JP) 2012-153854

(51) Int. Cl. G06F 3/041

(52) U.S. Cl. CPC G06F 3/0412
USPC 345/173

(57) ABSTRACT

Disclosed is an operation display device, including: a display unit; a touch panel to detect a touch operation which is carried out to a display surface of the display unit; a detecting unit to detect a relative direction of an operator who carries out the touch operation to the display surface of the display unit, the relative direction being a direction relative to the display surface; a control unit to control display contents of the display unit, wherein in case that the touch operation detected by the touch panel is a specific operation and that a direction of a window which is currently displayed by the display unit is not matched with the detected relative direction of the operator who carries out the touch operation, the control unit invalidates the touch operation.

### BACKGROUND OF THE INVENTION

1. Field of the Invention

The present invention relates to an operation display device comprising a touch panel, an operation display method and a tangible computer-readable recording medium.

2. Description of Related Art

There is a technology in which the direction of a finger is determined in accordance with the finger data obtained by reading a fingerprint or the like by a fingerprint sensor, the direction of a portable device is determined in accordance with the direction of the finger so as to turn the portable device right side up in case that the portable device is viewed from the user and the direction of a window displayed on the portable device is controlled so as to match the determined direction of the portable device (See Japanese Patent Application Publication No. 2010-20716).

Further, there is a technology in which in an apparatus having a touch panel, the contact area size of the contact part in which a finger contacts with the touch panel is calculated, and the apparatus recognizes that the first operation is received when the contact area size is not less than a threshold value and that the second operation is received when the contact area size is less than the threshold value (See Japanese Patent Application Publication No. 2010-182185).

A portable terminal having a comparatively large touch panel or a large-sized touch panel used for a conference system is commonly used in the situation in which a plurality of persons carry out the operations while the persons view a display window.

However, in case of a specific operation, it is desired that the touch operation to be carried out by another user except a main operator is prohibited. For example, the specific operation includes an operation for entering a password, an operation for setting a destination for the file transmission, an operation for starting the execution of a job, such as print, save, transmission and the like. In a conventional device, there has not been a function of prohibiting the touch operation to be carried out by another user.

### SUMMARY

To achieve at least one of the abovementioned objects, an operation display device reflecting one aspect of the present invention, comprises:

a display unit;

a touch panel to detect a touch operation which is carried out to a display surface of the display unit;

a detecting unit to detect a relative direction of an operator who carries out the touch operation to the display surface of the display unit, the relative direction being a direction relative to the display surface;

a control unit to control display contents of the display unit,

wherein in case that the touch operation detected by the touch panel is a specific operation and that a direction of a window which is currently displayed by the display unit is not matched with the detected relative direction of the operator who carries out the touch operation, the control unit invalidates the touch operation.

Preferably, the detecting unit detects the relative direction of the operator who carries out the touch operation with a finger, in accordance with a shape of a contact portion of the finger, which contacts to the display surface.

Preferably, when the control unit invalidates the touch operation detected by the touch panel, the control unit carries out a predetermined warning notice.

Preferably, the predetermined warning notice indicates contents for the operator by whom the window which is currently displayed by the display unit is viewed from a correct direction, and is displayed in a direction which is the same as the direction of the window.

Preferably, the predetermined warning notice indicates contents for the operator who carries out the invalidated touch operation, and is displayed in a correct direction from the operator who carries out the invalidated touch operation.

Preferably, the specific operation is at least one of an operation for entering security information, an operation for setting a transmission destination and an operation for starting an execution of a job.

Preferably, the control unit judges whether two touch operations which are received for the window which is currently displayed by the display unit, are carried out by one operator or not by comparing the shape of the contact portion of the finger relating to one of the two touch operations with the shape of the contact portion of the finger relating to the other of the two touch operations, and

in case that the control unit judges that the two touch operations are carried out by different operators, respectively, the control unit divides the display surface of the display unit into two areas, and instructs the display unit to display separate windows in the areas, respectively.

Preferably, when the control unit divides the display surface into the areas, the control unit preferentially assigns each touch operation to the area including a touch position of the each touch operation, and sets a direction of the separate window displayed in each area to a direction which is matched with the direction of the operator who carries out the touch operation assigned to the each area.

Preferably, after the control unit divides the display surface, the control unit instructs the display unit to display the separate window having display contents which are same as display contents of the window displayed by the display unit before dividing the display surface, in each area, and instructs the display unit to display an entry button in the separate window in each area so as not to be smaller than the entry button in the window displayed before dividing the display surface.

### BRIEF DESCRIPTION OF THE DRAWINGS

The present invention will become more fully understood from the detailed description given hereinafter and the accompanying drawings given by way of illustration only, and thus are not intended as a definition of the limits of the present invention, and wherein:

FIG. 1 is an explanatory view showing an example of the system configuration including the operation display device according to the embodiment and a multi function peripheral having the function of the operation display device;

FIG. 2 is a block diagram showing the electric schematic configuration of the operation display device according to the embodiment;

FIG. 3 is a block diagram showing the electric schematic configuration of the multi function peripheral having the function of the operation display device;

FIGS. 4A and 4B are explanatory views showing the situation in which a valid operation and an invalid operation are received to the password entry window;

FIGS. 5A and 5B are explanatory views showing the situation in which a valid operation and an invalid operation relating to the entry of the transmission destination are received;

FIGS. 6A and 6B are explanatory views showing the situation in which a valid operation and an invalid operation are received to the transmission button;

FIG. 7 is an explanatory view showing the situation in which a warning notice is displayed for a main operator when an invalid operation is received;

FIG. 8 is an explanatory view showing the situation in which a warning notice is displayed for an invalid operator when an invalid operation is received;

FIG. 9 is a flowchart showing the process which is carried out by the operation display device by which a touch operation is received;

FIGS. 10A and 10B are explanatory views showing the situation in which separate single touch operations are simultaneously received from two operators and the display surface S is divided into two areas;

FIG. 11 is an explanatory view showing the situation in which a warning notice is displayed for a main operator when an invalid operation is received from an opposite operator after dividing the display surface;

FIG. 12 is an explanatory view showing the situation in which a warning notice is displayed for an opposite operator from whom an invalid operation is received, after dividing the display surface;

FIG. 13 is a flowchart showing the process which is carried out when the operation display device having the function of dividing the display surface receives the touch operation;

FIG. 14 is a flowchart showing the detail of the division process (Step S211 in FIG. 13); and

FIG. 15 is a flowchart showing the process which is carried out when a touch operation is received in the situation in which the separate windows are displayed in the areas respectively after dividing the display surface.

### DETAILED DESCRIPTION OF PREFERRED EMBODIMENT

Hereinafter, a preferred embodiment of the present invention will be explained with reference to the accompanying drawings.

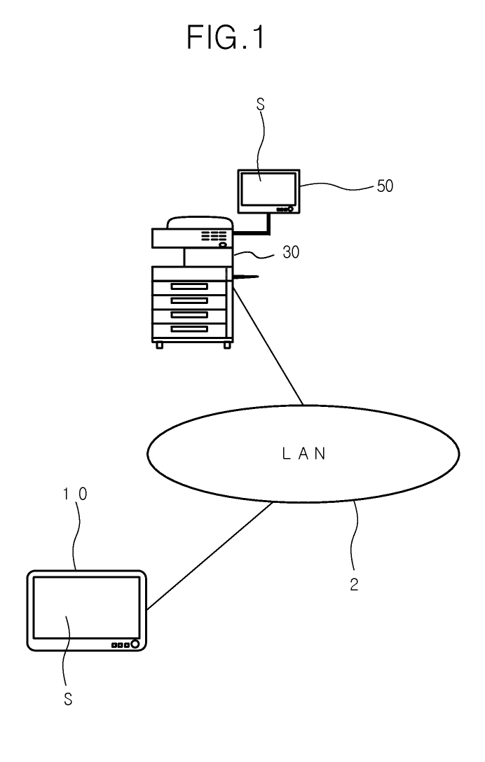

FIG. 1 shows an example of the system configuration including the operation display device 10 according to the embodiment and the multi function peripheral 30 having the function of the operation display device according to the embodiment. The operation display device 10 and the multi function peripheral 30 are connected via a network 2, such as LAN (Local Area Network) or the like.

The operation display device 10 is a portable terminal having a flat shape of approximate B5 size (182 mm×257 mm). The whole area of the surface of the operation display device 10 is almost the display surface S of the display unit for displaying various types of operation windows. On the whole area of the display surface S, a touch panel for detecting various types of operations carried out by the contact with the operator's fingers, is provided. For example, the operation display device 10 has the function of preparing and editing a document or image data, the function of remotely operating the multi function peripheral 30, and the like. The operation display device 10 can be commonly used in the situation in which a plurality of persons carry out the operations while the persons view a display window.

The multi function peripheral 30 is an image processing apparatus having a copy function of printing an image on recording paper by optically reading an image of an original, a scan function of obtaining image data by reading an image of an original to store the image data as a file or to transmit the image data to an external terminal, a PC print function of printing out an image by forming an image relating to a print job received from an external terminal, such as a personal computer, on the recording paper, a facsimile function of transmitting and receiving the image data, and the like.

The multi function peripheral 30 comprises a large-sized operation panel 50. The operation panel 50 is formed in a rectangular flat shape like the operation display device 10 and has a large-sized (for example, A4 size (210 mm×297 mm)) display surface S for displaying the operation windows or the like thereon. Further, on the whole area of the display surface S, a touch panel for detecting a touch operation carried by the contact with an operator's finger, is provided. The operation panel 50 can be commonly used in the situation in which a plurality of persons carry out the operations while the persons view a display window.

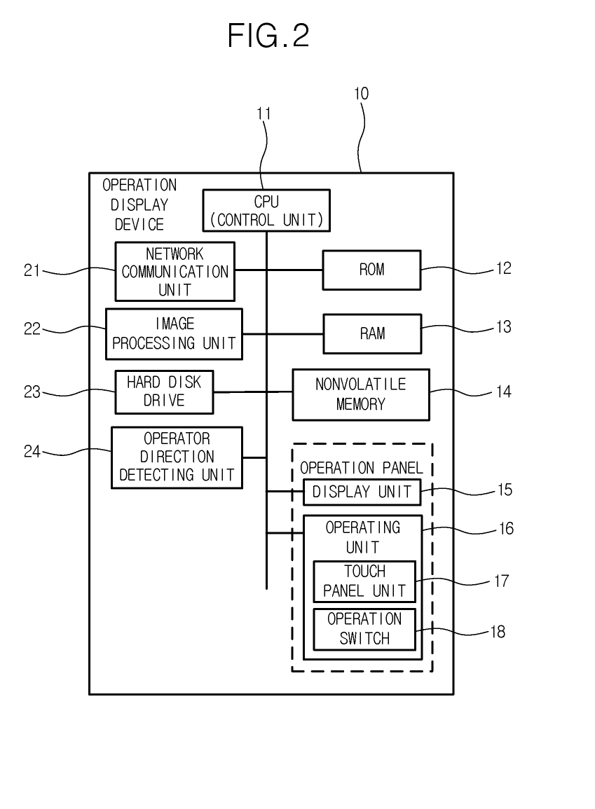

FIG. 2 shows the electric schematic configuration of the operation display device 10. In the operation display device 10, the CPU 11 which functions as the control unit for controlling the entire operation of the operation display device 10, is connected with a ROM (Read Only Memory) 12, a RAM (Random Access Memory) 13, a nonvolatile memory 14, a display unit 15, an operating unit 16, a network communication unit 21, an image processing unit 22, a hard disk drive 23, the operator direction detecting unit 24 and the like via a bus.

In the ROM 12, various types of programs and data are stored. By carrying out various types of processes by the CPU 11 in accordance with these programs, each function of the operation display device 10 is realized. The RAM 13 is used as a work memory for temporarily storing various data when the CPU 11 executes the programs, and a memory for temporarily storing display data.

The nonvolatile memory 14 is a memory in which the stored contents are held even if the operation display device 10 is turned off. In the nonvolatile memory 14, various types of setting contents, user information, communication information (network address and the like) and the like are stored. The hard disk drive 23 is a nonvolatile memory device having the large capacity.

The display unit 15 comprises a liquid crystal display or the like, and displays various types of operation windows, setting windows and the like. The display unit 15 displays the window corresponding to the display data stored in a predetermined area of the RAM 13. The CPU 11 prepares and processes the display data.

The operating unit 16 comprises the touch panel unit 17 for detecting the touch operations to the display surface S of the display unit 15, and some operation switches 18. The touch panel unit 17 can simultaneously detect the touch operations to a plurality of portions. The detecting method of the touch panel unit 17 may be optionally selected, such as electrostatic capacitance, analog/digital resistive films, infrared rays, ultrasonic waves, electromagnetic induction or the like.

The operator direction detecting unit 24 detects the relative direction of the operator who carries out the touch operation. The relative direction is a direction relative to the display surface S. In this embodiment, the operator direction detecting unit 24 detects the shape of the contact part of the finger, which contacts to the display surface S (hereinafter, simply referred to as “finger shape”). Further, the operator direction detecting unit 24 detects the relative direction of the operator who carries out the touch operation in accordance with the finger shape. Specifically, the operator direction detecting unit 24 calculates the direction of the finger as the direction of the operator from the shape of the contact portion of the finger, which contacts to the display surface S, and the like. In another example of the operation display device 10, the operator direction detecting unit 24 may only detect the finger shape, and the CPU 11 may carry out the process for calculating the direction of the operator in accordance with the detected finger shape.

The network communication unit 21 has the function of communicating with the multi function peripheral 30 and various types of external devices by connecting with the network 2 via wireless communication. For example, in case that a multi function peripheral 30 is remotely controlled from the operation display device 10, the network communication unit 21 is used for the communication between the operation display device 10 and the multi function peripheral 30 to be operated.

The image processing unit 22 has the function of processing the display data to be displayed by the display unit 15. For example, the image processing unit 22 processes the display data to enlarge or reduce the window or to rotate the data.

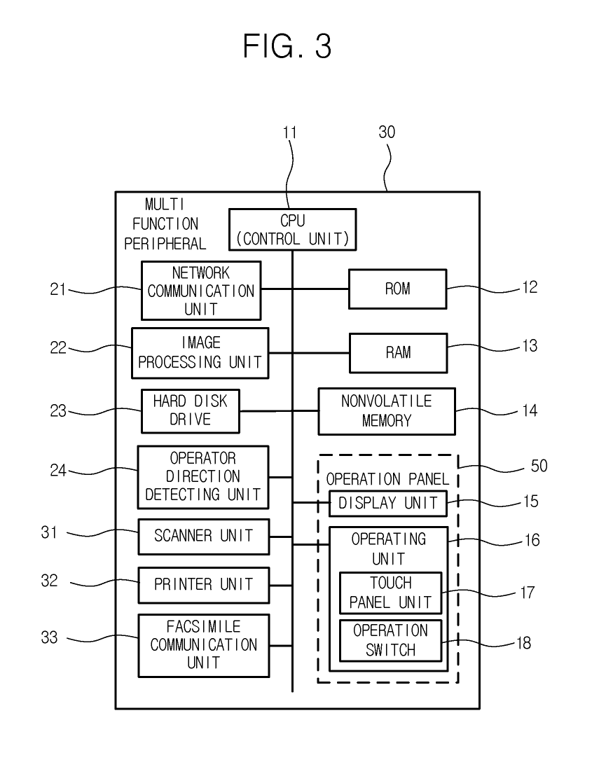

FIG. 3 is the block diagram showing the schematic configuration of the multi function peripheral 30. The elements of the multi function peripheral 30, which are the same as those of the operation display device 10 are denoted by the reference numerals which are the same as those of the operation display device 10, respectively. The explanation of the same elements is arbitrarily omitted.

In the multi function peripheral 30, the CPU 11 for controlling the operation of the multi function peripheral 30 is connected with a ROM 12, a RAM 13, a nonvolatile memory 14, a display unit 15, an operating unit 16, a network communication unit 21, an image processing unit 22, a hard disk drive 23, a operator direction detecting unit 24 and the like via a bus. These elements are ones having the function of the operation display device 10.

Further, the multi function peripheral 30 comprises a scanner unit 31, a printer unit 32 and a facsimile communication unit 33 which are connected with the CPU 11 via the bus.

The scanner unit 31 obtains image data by optically reading an image of an original. For example, the scanner unit 31 comprises a light source for irradiating the original with light, a line image sensor for reading the original line by line in the width direction of the original by receiving the reflected light from the original, an optical system having lenses, mirrors and the like for guiding the reflected light from the original to the line image sensor and focusing the reflected light on the line image sensor, a moving mechanism for sequentially moving the reading position by moving the mirror and the light source line by line in the longitudinal direction of the original, and the like.

The printer unit 32 prints out an image by forming an image on recording paper in accordance with image data by the electrophotographic process. For example, the printer unit 32 is configured as so-called laser printer comprising a conveying device for the recording paper, a photoconductive drum, a charging device, a LD (Laser Diode) which is switched on/off in accordance with the input image data, a scanning unit for scanning the photoconductive drum by the laser light emitted from the LD, a developing device, a transfer and separation device, a cleaning device and a fixing device. The printer unit 32 may be an LED printer in which the photoconductive drum is irradiated by using LEDs (Light Emitting Diode) instead of laser light, or another type of printer.

The facsimile communication unit 33 carries out the facsimile communication by carrying out the protocol control relating to the facsimile communication.

In the ROM 12, various types of programs and data are stored. By carrying out various types of processes by the CPU 11 in accordance with these programs, each function of the multi function peripheral 30 is realized. The RAM 13 is used as a work memory for temporarily storing various types of data when the CPU 11 executes the programs, and as a memory for temporarily storing display data, image data and the like.

The hard disk drive 23 is used for storing image data of the original, which is obtained by reading an image of the original by the scanner unit 31, print data received from an external PC (Personal Computer) or the like, image data received via the facsimile communication, and the like.

The display unit 15 displays various types of operation windows and setting windows for operating the multi function peripheral 30. The operating unit 16 receives various types of operations for actuating the multi function peripheral 30, from the operator. The display unit 15 and the operating unit 16 constitute the operation panel 50 of the multi function peripheral 30.

The image processing unit 22 carries out the image processings, such as image correction, rotation, enlargement/reduction, compression/decompression and the like, for image data and display data to be displayed by the display unit 15.

Both of the operation display device 10 and the multi function peripheral 30 have the function of examining whether the direction of the operator who carries out the touch operation detected by the touch panel unit 17 is matched with the direction of the window which is currently displayed by the display unit 15, in case that the touch operation is the predetermined specific operation. Further, both of the operation display device 10 and the multi function peripheral 30 have the function of invalidating the touch operation incase that the direction of the operator is not matched with the direction of the window.

Hereinafter, the case in which the multi function peripheral 30 is remotely controlled by the operation display device 10, will be explained. Also in case that the multi function peripheral 30 is operated via the operation panel 50 by displaying the window on the operation panel 50, the display contents of the window displayed on the operation panel 50 and the operation of the multi function peripheral 30 are same as those in case that the multi function peripheral 30 is remotely controlled. Therefore, the explanation thereof is omitted.

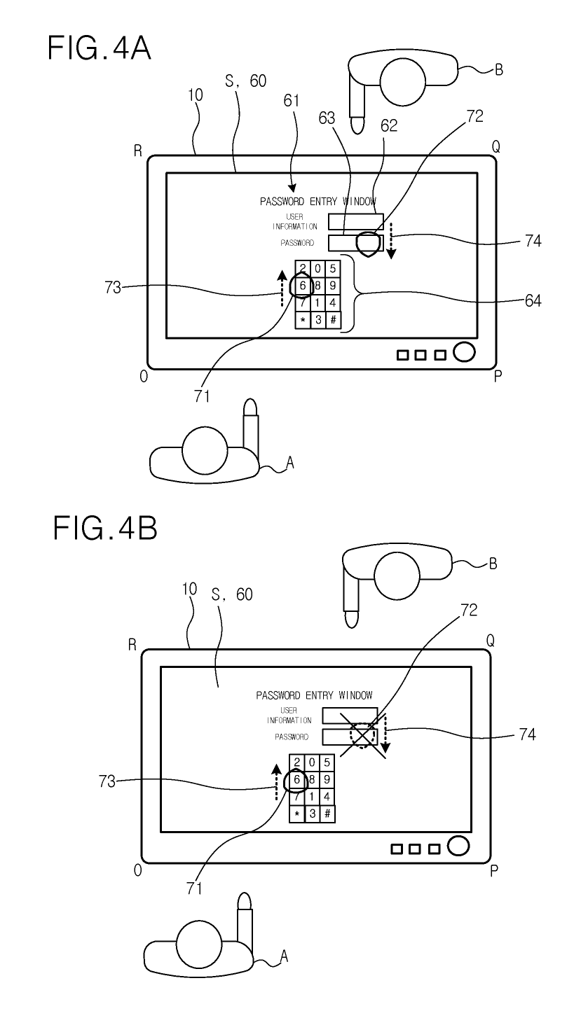

FIGS. 4A and 4B show the situation in which the operation is received by displaying the password entry window 60 for receiving the entry of the password, on the display surface S. In the password entry window 60, the title 61 of the window, the user information entry box 62, the password entry box 63 and the numerical keypad 64 for receiving the entry of the password (security information), are displayed. Because the password entry window 60 receives the entry of the security information, all of the operations to be carried out to this window 60 are treated as the specific operations. That is, in the password entry window 60, only the operations carried out by a main operator (the operator who carries out the operations from a correct direction from which the window is viewed so as to turn the window right side up) are accepted, and the operations carried out by another operator (the operator who carries out the operations from the direction except the correct direction from which the window is viewed so as to turn the window right side up) are invalidated.

In FIGS. 4A and 4B, in the situation in which the operator A stands to the side OP of the rectangular display surface S having the points O, P, Q and R and faces toward the side QR, the operator A carries out the push operation on the touch position 71 with his/her finger. In the situation in which the operator B stands to the side QR of the display surface S and faces toward the side OP, the operator B carries out the push operation on the touch position 72 with his/her finger. In the drawings, on the touch positions 71 and 72, the shapes of the contact parts of the fingers, which contact to the display surface S are shown respectively. The password entry window 60 is displayed so as to turn the window 60 right side up in case that the window 60 is viewed from the operator A. Therefore, the operator A is the main operator, and the operator B is another operator.

When the touch panel unit 17 detects the touch operation, the operator direction detecting unit 24 judges the relative direction of the operator who carries out the touch operation to the touch position, in accordance with the shape of the contact part of the finger, which contacts to the touch position. The relative direction is a direction relative to the display surface S. In case of FIGS. 4A and 4B, the operator direction detecting unit 24 judges that the direction of the operator A who carries out the touch operation to the touch position 71 is the direction of the arrow 73 pointing toward the side QR from the side OP in accordance with the finger shape on the touch position 71. Further, the operator direction detecting unit 24 judges that the direction of the operator B who carries out the touch operation to the touch position 72 is the direction of the arrow 74 pointing toward the side OP from the side QR in accordance with the finger shape on the touch operation 72.

The CPU 11 examines whether the direction of the operator who carries out the touch operation to the touch position, which is judged by the operator direction detecting unit 24 is matched with the direction of the window which is currently displayed. In case that the direction of the operator is matched with the direction of the window, the touch operation carried out to the touch position is validated. In case that the direction of the operator is not matched with the direction of the window, the touch operation carried out to the touch position is invalidated. For example, when the difference between the direction of the operator and the direction of the window is within 45 degrees, the CPU 11 judges that the direction of the operator is matched with the direction of the window. When the above difference is not less than 45 degrees, the CPU 11 judges that the direction of the operator is not matched with the direction of the window. The acceptable range of the above difference can be optionally set.

In the example of FIGS. 4A and 4B, as shown in FIG. 4B, the operation carried out to the touch position 71 is validated because the direction of the operator A is the same as the direction of the password entry window 60 which is currently displayed. The operation carried out to the touch position 72 is invalidated because the direction of the operator B is opposite to the direction of the password entry window 60. In the drawings, the invalid operation is shown by a dashed line and is marked with “X”.

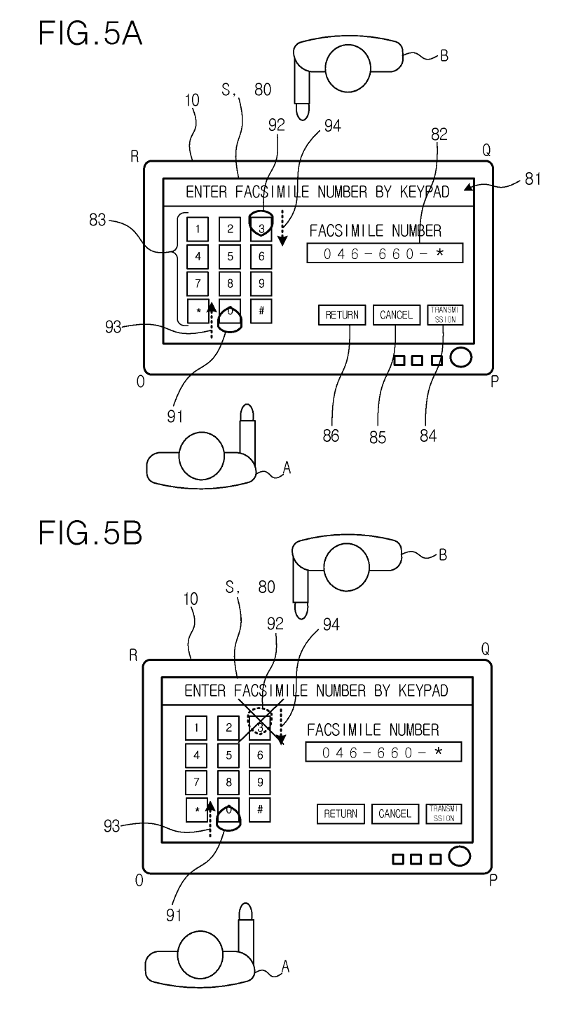

FIGS. 5A and 5B show the situation in which the operation is received by displaying the destination setting window 80 for receiving the entry of the transmission destination, on the display surface S. The destination setting window 80 is a window for setting the destination of the facsimile transmission. In the destination setting window 80, the guidance message 81 for explaining the operation, the destination entry box 82 in which the phone number of the destination is entered, the numerical keypad 83 for entering the phone number and the like, are displayed. Further, the transmission button 84 for instructing the transmission, the cancel button 85 for cancelling the contents entered in the destination entry box 82 and the return button 86 for cancelling the entry in the destination setting window 80 and returning to the previous window, are displayed.

The operation for entering the destination in the destination setting window 80 is treated as the specific operation. Only the operations carried out by the main operator are accepted, and the operations carried out by another operator are invalidated.

In FIGS. 5A and 5B, in the situation in which the operator A stands to the side OP of the rectangular display surface S having the points O, P, Q and R and faces toward the side QR, the operator A carries out the push operation on the touch position 91 (the key “O” of the numerical keypad 83) with his/her finger. In the situation in which the operator B stands to the side QR of the display surface S and faces toward the side OP, the operator B carries out the push operation on the touch position 92 (the key “3” of the numerical keypad 83) with his/her finger. The destination setting window 80 is displayed so as to turn the window 80 right side up in case that the window 80 is viewed from the operator A.

In case of FIGS. 5A and 5B, the operator direction detecting unit 24 judges that the direction of the operator A who carries out the touch operation to the touch position 91 is the direction of the arrow 93 pointing toward the side QR from the side OP in accordance with the finger shape on the touch position 91. Further, the operator direction detecting unit 24 judges that the direction of the operator B who carries out the touch operation to the touch position 92 is the direction of the arrow 94 pointing toward the side OP from the side QR in accordance with the finger shape on the touch operation 92.

The CPU 11 examines whether the direction of the operator who carries out the touch operation to the touch position, which is judged by the operator direction detecting unit 24 is matched with the direction of the window which is currently displayed. In case that the direction of the operator is matched with the direction of the window, the touch operation carried out to the touch position is validated. In case that the direction of the operator is not matched with the direction of the window, the touch operation carried out to the touch position is invalidated. In the example of FIGS. 5A and 5B, as shown in FIG. 5B, the operation carried out to the touch position 91 is validated because the direction of the operator A is the same as the direction of the destination setting window 80 which is currently displayed. The operation carried out to the touch position 92 is invalidated because the direction of the operator B is opposite to the direction of the destination setting window 80.

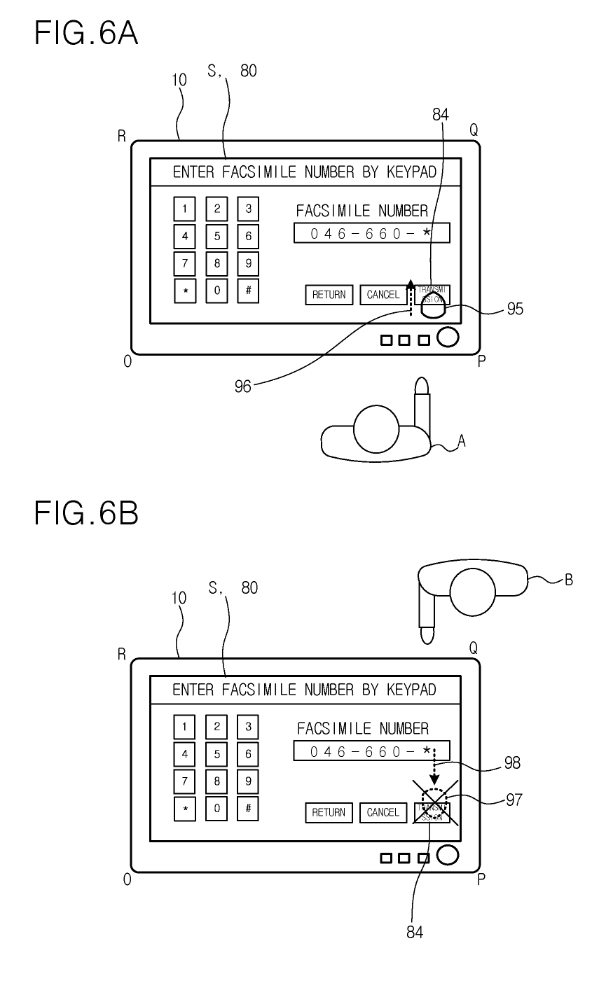

FIGS. 6A and 6B show the case in which the transmission button 84 is operated in the destination setting window 80 displayed in the same direction as that of FIGS. 5A and 5B. Because the transmission button 84 is a button for instructing the start of the execution of the job, the operation to be carried out for the transmission button 84 is treated as the specific operation. Only the operation carried out by the main operator is accepted, and the operation carried out by another operator is invalidated.

In FIG. 6A, in the situation in which the operator A stands to the side OP of the rectangular display surface S having the points O, P, Q and R and faces toward the side QR, the operator A operates the transmission button 84 by pushing the touch position 95 with his/her finger. The operator direction detecting unit 24 judges that the direction of the operator A who carries out the touch operation to the touch position 95 is the direction of the arrow 96 pointing toward the side QR from the side OP in accordance with the finger shape on the touch position 95. The CPU 11 judges whether the direction of the operator A who carries out the touch operation to the touch position 95 is matched with the direction of the destination setting window 80 which is currently displayed. In this case, because the direction of the operator A is matched with the direction of the destination setting window 80, the operation carried out to the touch position 95 is validated and the transmission is executed.

In FIG. 6B, in the situation in which the operator B stands to the side QR of the display surface S and faces toward the side OP, the operator B operates the transmission button 84 by pushing the touch position 97 with his/her finger. The operator direction detecting unit 24 judges that the direction of the operator B who carries out the touch operation to the touch position 97 is the direction of the arrow 98 pointing toward the side OP from the side QR in accordance with the finger shape on the touch position 97. In this case, because the direction of the operator B who carries out the touch operation to the touch position 97 is not matched with the direction of the destination setting window 80, the operation carried out to the touch position 97 is invalidated and the transmission is not executed.

Next, the warning notice which is displayed when an invalid operation is received, will be explained.

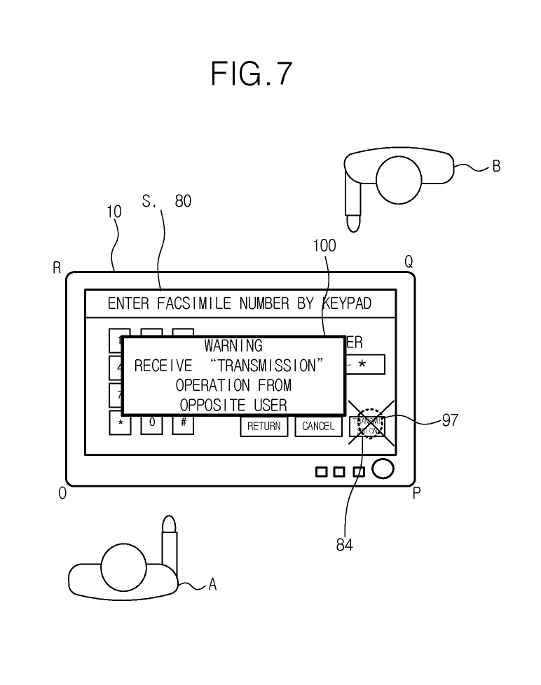

FIG. 7 shows the situation in which the warning notice 100 is displayed on the destination setting window 80. In an example of FIG. 7, the following situation is shown. When the touch operation is received for the touch position 97 shown in FIG. 6B, that is, for the transmission button 84 from the operator B who faces in the opposite direction to the destination setting window 80, the touch operation is invalidated. The warning notice 100 indicating the warning message for the main operator A by whom the destination setting window 80 is viewed from the correct direction, is displayed in the correct direction from the operator A, that is, in the same direction as the destination setting window 80.

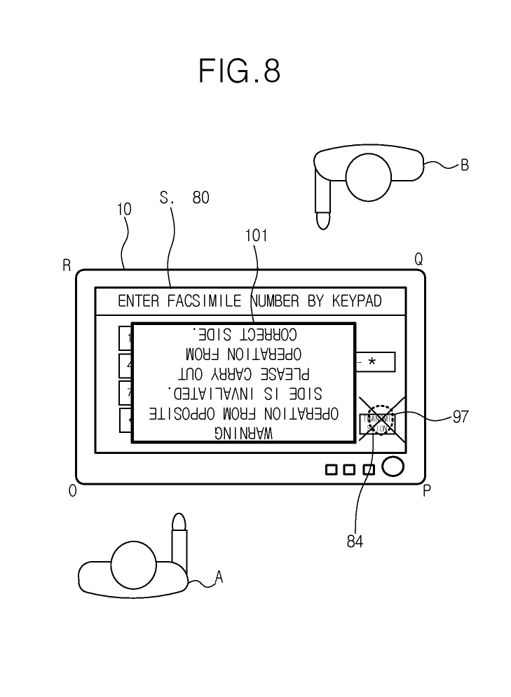

In an example of FIG. 8, similarly to FIG. 7, the following situation is shown. When the touch operation carried out for the transmission button 84 to the touch position 97 is invalidated, the warning notice 101 is displayed for the operator B who carries out the invalid touch operation. In FIG. 8, the warning notice 101 for indicating the warning message for the operator B who carries out the invalid operation is displayed in the correct direction from the operator B.

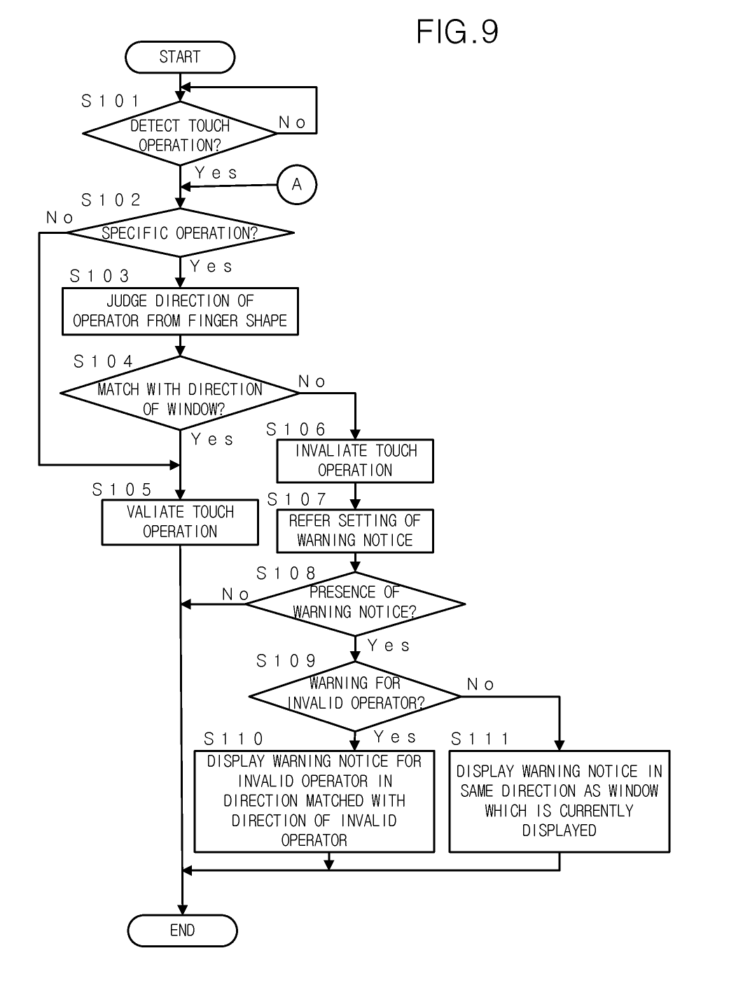

FIG. 9 shows the flowchart of the process carried out by the operation display device 10. When the touch panel unit 17 detects the touch operation (Step S101; Yes), the CPU 11 judges whether the touch operation is the predetermined specific operation (Step S102). In this case, the specific operation includes the operation for entering the security information, the operation for setting the transmission destination, the operation for starting the execution of the job, and the like. For example, the setting of the transmission destination includes the entry of the destination for the facsimile transmission, the setting operation for the multi-address transmission, the entry of the destination in the function of attaching a file of image data obtained by reading an image with the scanner unit 31, to an electronic mail and transmitting the file (Scan to E-mail), the entry of the destination in the function of transmitting a file of image data obtained by reading the image with the scanner unit 31 in the SMB (Server Message Block) protocol (Scan to SMB), and the like.

In case that the detected touch operation is not the specific operation (Step S102; No), the CPU 11 judges that the touch operation is the valid operation and carries out the corresponding process (Step S105). Then, the process shown in FIG. 9 is ended (End). For example, the CPU 11 changes the display contents and the settings or executes the job in accordance with the touch operation.

In case that the detected touch operation is the specific operation (Step S102; Yes), the CPU 11 obtains the direction of the operator who carries out the touch operation, from the operator direction detecting unit 24 in accordance with the finger shape relating to the touch operation (Step S103).

The CPU 11 examines whether the direction of the operator, which is obtained from the operator direction detecting unit 24 is matched with the direction of the window which is currently displayed (Step S104). In case that the direction of the operator is matched with the direction of the window (Step S104; Yes), the CPU 11 judges that the touch operation is the valid operation and carries out the corresponding process (Step S105). Then, the process shown in FIG. 9 is ended (End).

In case that the direction of the operator, which is obtained from the operator direction detecting unit 24 is not matched with the direction of the window which is currently displayed (Step S104; No), the CPU 11 treats the touch operation as the invalid operation (Step S106). Then, the CPU 11 refers the registered contents of the setting relating to the warning notice (Step S107). The setting relating to the warning notice is set by previously receiving the operation from the user via a predetermined setting window and is registered in the nonvolatile memory 14 or the like. The setting items relating to the warning notice include (1) the presence or absence of the warning notice and (2) the operator to be noticed. In the item (2), the operator who carries out the invalid operation (invalid operator) or the main operator is selected as the operator to be noticed.

In case that the above item (1) is set to the absence of the warning notice (Step S108; No), the CPU 11 ends the process shown in FIG. 9 (End).

In case that the above item (1) is set to the presence of the warning notice (Step S108; Yes), the CPU 11 examines whether the above item (2) is set to “invalid operator” (Step S109). In case that the item (2) is set to “invalid operator” (Step S109; Yes), the CPU 11 instructs the display unit 15 to display the warning notice indicating the contents for the invalid operator, in the direction which is matched with the direction of the invalid operator (Step S110). Then, the process shown in FIG. 9 is ended (End).

In case that the above item (2) is not set to “invalid operator”, that is, the above item (2) is set to the main operator (Step S109; No), the CPU 11 instructs the display unit 15 to display the warning notice indicating the contents for the main operator, in the same direction as the window which is currently displayed (Step S111). Then, the process shown in FIG. 9 is ended (End).

As described above, when the touch operation for carrying out the specific operation is received, the operation display device 10 detects the direction of the operator who carries out the touch operation and invalidates the touch operation in case that the direction of the window which is currently displayed is not matched with the direction of the operator. Therefore, even though a plurality of persons view the display window and commonly use the operation display device 10, in case of the specific operation, it is possible to prohibit the touch operation carried out by another user except the main operator.

Further, in case of the operations except the specific operation, because the touch operation carried out by another user is validated, it is possible to operate the operation display device 10 by a plurality of persons while a plurality of persons view the window which is currently displayed.

Next, the case in which when the touch operations carried out by a plurality of operators are simultaneously detected, the display surface S is divided into the number of areas, which corresponds to the number of operators, will be explained.

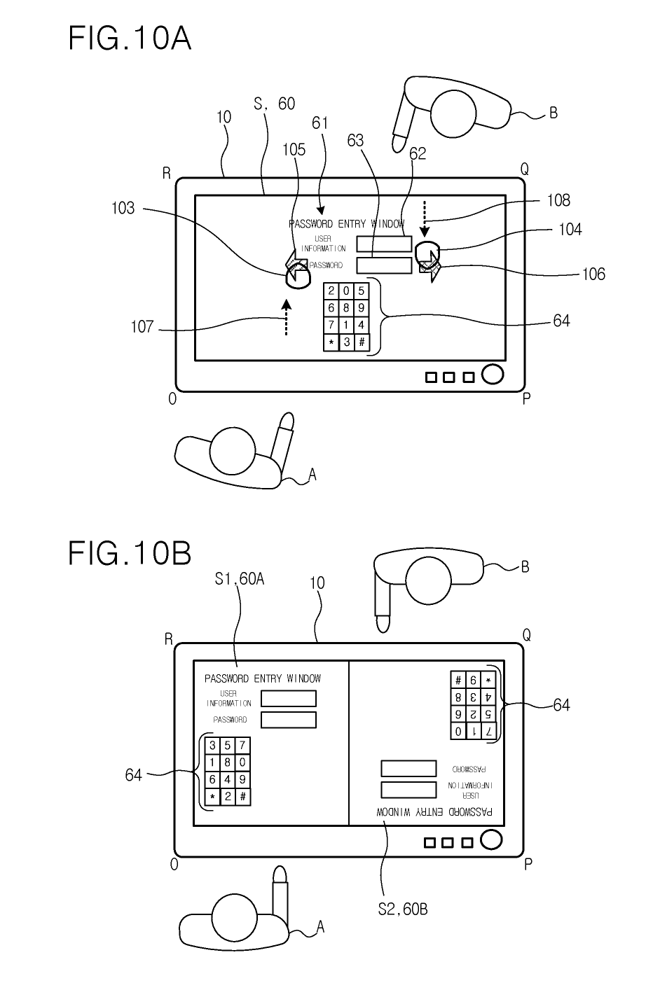

FIGS. 10A and 10B show the case in which a plurality of touch operations which are simultaneously detected are separate single touch operations carried out by two operators, respectively. As shown in FIG. 10A, when the touch panel unit 17 simultaneously detects the first touch operation 103 in which after the operator touches the display surface S on the initial point of the left arrow 105, the operator flicks the display surface S in the direction of the left arrow 105, and the second touch operation 104 in which after the operator touches the display surface S on the initial point of the right arrow 106, the operator flicks the display surface S in the direction of the right arrow 106, the CPU 11 judges whether the first touch operation 103 and the second touch operation 104 are the multi-touch operation carried out by one operator or the separate single touch operations carried out by two operators respectively.

For example, in case that the direction of the operator, which is calculated from the finger shape relating to the first touch operation 103 and the direction of the operator, which is calculated from the finger shape relating to the second touch operation 104 are the same (the difference in the direction between the above two directions is within the predetermined acceptable range, for example, less than 45 degrees), or in case that the directions of the operators are the same and the distance between the touch position of the first touch operation 103 and the touch position of the second touch operation 104 is not more than a predetermined acceptable distance (for example, 15 cm), the CPU 11 judges that the above two touch operations are the multi-touch operation carried out by one operator.

In case that the direction of the operator, which is calculated from the finger shape relating to the first touch operation 103 is greatly different from the direction of the operator, which is calculated from the finger shape relating to the second touch operation 104 (for example, the difference between the above two directions is not less than 45 degrees or the above two directions are opposite each other), or in case that the distance between the touch position of the first touch operation 103 and the touch position of the second touch operation 104 exceeds a predetermined distance, the CPU 11 judges that the above two touch operations are the separate single touch operations carried out by two operators respectively.

The judgment method for judging whether a plurality of operations are the operation carried out by one operator, is not limited to the above method. For example, the CPU 11 may judge whether a plurality of touch operations are the operation carried out by one operator or the operations carried out by a plurality of operators in accordance with the similarity between the finger shapes (size or outline). Further, the CPU 11 may judge whether the touch operations are carried out by one operator in accordance with the information except the finger shape.

In case of FIG. 10A, the direction of the operator, which is calculated from the finger shape relating to the first touch operation 103 is the direction of the arrow 107 and the direction of the operator, which is calculated from the finger shape relating to the second touch operation 104 is the direction of the arrow 108. Because the above two directions are different from each other, the CPU 11 judges that the above two touch operations are separate single touch operations carried out by two operators respectively. Further, the CPU 11 recognizes that the first touch operation 103 is the flick operation in the left direction by the operator A and the second touch operation 104 is the flick operation in the right direction by the operator B.

As a result, as shown in FIG. 10B, the CPU 11 divides the display surface S of the display unit 15 into two areas S1 and S2, and instructs the display unit 15 to display separate windows in the areas S1 and S2, respectively. Further, the touch panel unit 17 receives an operation independently in each of the separate windows. In this example, the display surface S is divided into the left area and the right area. Further, in each of the areas S1 and S2, the separate window having the display contents (items) which are the same as those of the window displayed before dividing the display surface S is displayed so as to change the layout therein. After dividing the display surface S, the entry button (operation buttons) is displayed so as not to be smaller than that in the window displayed before dividing the display surface S. In this case, the entry button displayed after dividing the display surface S has the same size as that in the window displayed before dividing the display surface S.

In the example of FIGS. 10A and 10B, before dividing the display surface S, as shown in FIG. 10A, the password entry window 60 is displayed. After dividing the display surface S, as shown in FIG. 10B, the password entry window 60A is displayed in the left area S1, and the password entry window 60B is displayed in the right area S2. In the password entry window 60A displayed in the left area S1, the numerical keypad 64 is shifted to the left end of the area S1. In the password entry window 60B displayed in the right area S2, the numerical keypad 64 is shifted to the right end of the area S2. Further, the key arrangements of the numerical keypads 64 in the password entry windows 60A and 60B displayed in the areas S1 and S2 respectively, are different from each other.

Because the numerical keypad 64 has entry buttons for entering the password (security information), it is important to prevent the contents of the operation from being leaked to the adjacent operator. Therefore, by arranging the numerical keypads 64 so as to be apart from each other in the separate password entry windows displayed in the area S1 and S2 respectively, it is difficult for the adjacent operator to view the operation to the numerical keypad 64. Further, by dissimilating the key arrangements of the numerical keypads 64 from each other, the contents of the operation cannot be guessed from the motion of the finger. Each entry button in the numerical keypad 64 displayed after dividing the display surface S has the same size as each entry button in the numerical keypad 64 displayed before dividing the display surface S.

Next, the warning notice which is displayed when the invalid operation is received for the separate window displayed in the area after dividing the display surface S, will be explained.

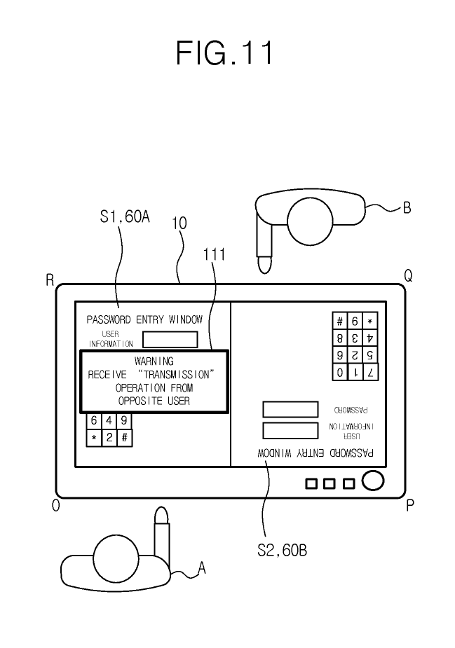

FIG. 11 shows an example of the warning notice 111 which is displayed when the operator B carries out the touch operation (invalid operation) from the opposite direction for the password entry window 60A displayed in the area S1 in the status shown in FIG. 10B. The warning notice 111 is one indicating the contents for the main operator A of the password entry window 60A displayed on the area S1. The warning notice 111 is displayed on the password entry window 60A in the same direction as the password entry window 60A.

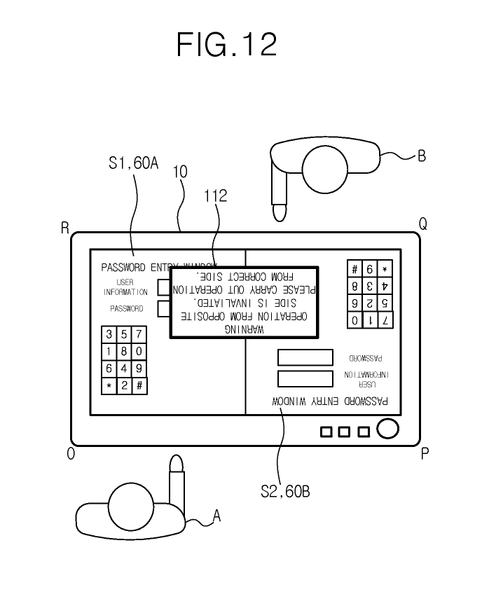

FIG. 12 shows another example of the warning notice 112 which is displayed when the operator B carries out the touch operation (invalid operation) from the opposite direction for the password entry window 60A displayed in the area S1 in the status shown in FIG. 10B. The warning notice 112 is one indicating the contents for the main operator B of the password entry window 60B displayed on the area S2. The warning notice 112 is displayed on the two password entry windows 60A and 60B so as to straddle the two password entry windows 60A and 60B and is displayed in the same direction as the password entry window 60B.

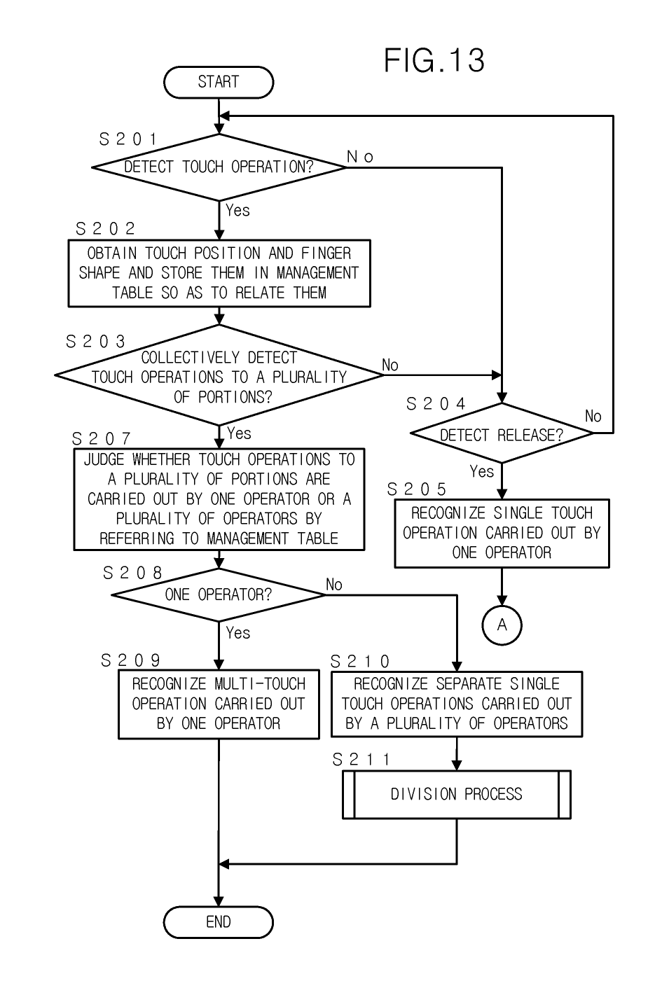

FIG. 13 shows the flowchart of the process to be carried out by the operation display device 10 having the function of dividing the display surface S as described above. When the touch panel unit 17 detects the touch operation (Step S201; Yes), the position information indicating the touch position of the touch operation and the information indicating the shape of the finger with which the touch operation is carried out, are registered so as to relate them to each other (Step S202).

Next, the CPU 11 judges whether the touch operations to a plurality of portions are collectively detected on the display surface S (Step S203). In case that the touch operation is detected only on one portion (Step S203; No), the CPU 11 examines whether the touch operation is released (the finger is released from the display surface S) (Step S204). In case that the touch operation is released (Step S204; Yes), the CPU 11 judges that the touch operation is a single touch operation carried out by one operator (Step S205). The process proceeds to Step S102 in FIG. 9. Then, the following process is carried out.

In case that the touch operation is not released (Step S204; No), the CPU 11 examines whether a new touch operation is detected in Step S201. In case that the new touch operation is not received (Step S201; No), the CPU 11 examines whether the touch operation is released or not in Step S204 again.

In case that the touch operations to a plurality of portions are collectively detected (Step S203; Yes), the CPU 11 judges whether the touch operations to a plurality of portions are the multi-touch operation carried out by one operator in accordance with the information registered in the management table (Step S207).

In case that the CPU 11 judges “one operator” (Step S208; Yes), the CPU 11 recognizes that a plurality of touch operations registered in the management table are the multi-touch operation carried out by one operator. Further, the CPU 11 carries out the process (the process for changing the display contents and outputting the contents of the operation to the multi function peripheral 300 or the like) corresponding to the multi-touch operation (for example, the pinch in, the pinch out or the like) (Step S209). Then, the process shown in FIG. 13 is ended.

In case that the CPU 11 does not judge “one operator” (Step S208; No), the CPU 11 recognizes that a plurality of touch operations registered in the management table are separate single touch operations carried out by a plurality of operators (Step S210). The CPU 11 carries out the division process for dividing the display surface S into a plurality of areas (Step S211). Then, the process shown in FIG. 13 is ended.

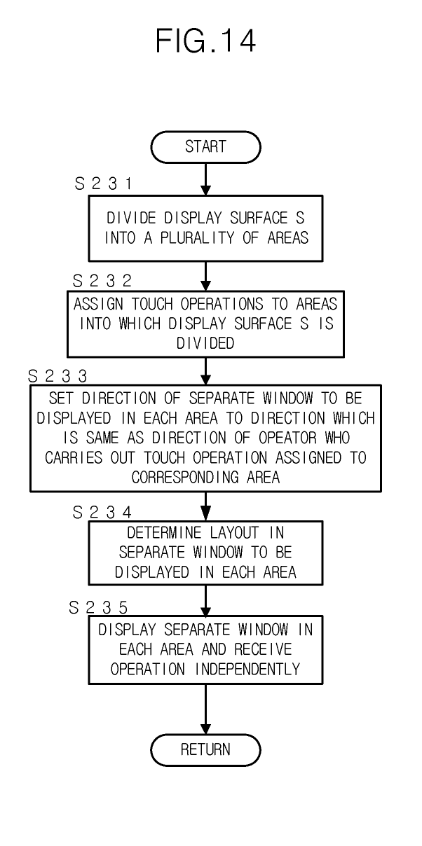

FIG. 14 shows the detail of the division process (Step S211 in FIG. 13). The CPU 11 divides the display surface S into a plurality of areas (Step S231). For example, the display surface S is equally divided into the right area and the left area, or into the upper area and the lower area. Next, a plurality of touch operations which are simultaneously detected are assigned to the areas into which the display surface S is divided, one by one (Step S232). At this time, the CPU 11 preferentially assigns the touch operation to the area including the touch position of the above touch operation. For example, the CPU 11 preferentially assigns the touch operation to the area of which the center is the closest to the touch position of the above touch operation.

Next, the CPU 11 sets the direction of the separate window displayed in each area, to the direction which is the same as the direction of the operator who carries out the touch operation assigned to the corresponding area (Step S233). Further, the CPU 11 determines the layout in the separate window displayed in each area. For example, each layout is changed to arrange the entry keys for entering the security information so as to be apart from each other. The entry button (operation buttons) is displayed so as not to be smaller than that in the window displayed before dividing the display surface S. In this case, the entry button displayed after dividing the display surface S has the same size as that in the window displayed before dividing the display surface S.

Then, the CPU 11 instructs the display unit 15 to display the separate window in each area so as to comply with the set direction and the determined layout. The operation display device 10 changes to the situation in which the operation can be received independently in each separate window (Step S235), and the process shown in FIG. 14 is ended (Return).

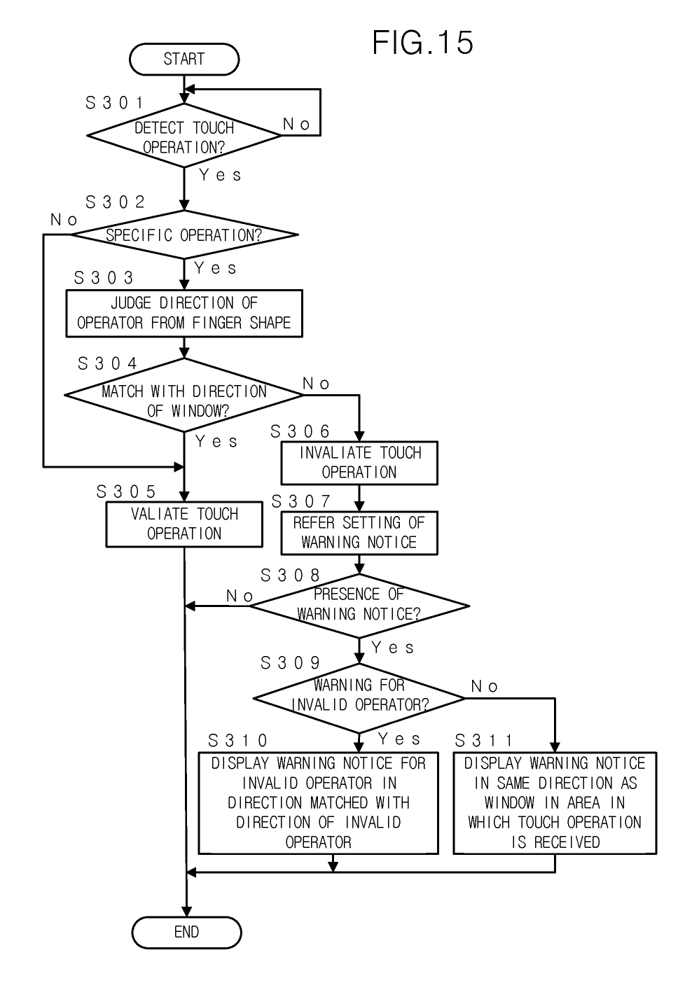

FIG. 15 shows the process which is carried out when the touch operation is received in the situation in which the separate windows are displayed in the areas respectively after dividing the display surface S. When the touch panel unit 17 detects a touch operation (Step S301; Yes), the CPU 11 judges whether the touch operation is the predetermined specific operation (Step S302). In case that the detected touch operation is not the specific operation (Step S302; No), the CPU 11 judges that the touch operation is the valid operation and carries out the corresponding process (Step S305). Then, the process shown in FIG. 15 is ended (End).

In case that the detected touch operation is the specific operation (Step S302; Yes), the CPU 11 obtains the direction of the operator who carries out the touch operation, from the operator direction detecting unit 24 in accordance with the finger shape relating to the touch operation (Step S303).

The CPU 11 examines whether the direction of the operator, which is obtained from the operator direction detecting unit 24 is matched with the direction of the separate window which is currently displayed in the area in which the touch operation is received (Step S304). In case that the direction of the operator is matched with the direction of the separate window (Step S304; Yes), the CPU 11 judges that the touch operation is the valid operation and carries out the corresponding process (Step S305). Then, the process shown in FIG. 15 is ended (End).

In case that the direction of the operator is not matched with the direction of the separate window (Step S304; No), the CPU 11 treats the touch operation as the invalid operation (Step S306). Then, the CPU 11 refers the registered contents of the setting relating to the warning notice (Step S307). In case that the setting relating to the warning notice is set to the absence of the warning notice (Step S308; No), the CPU 11 ends the process shown in FIG. 15 (End).

In case that the setting relating to the warning notice is set to the presence of the warning notice (Step S308; Yes), the CPU 11 examines whether the operator to be noticed is set to “invalid operator” (Step S309). In case that the operator to be noticed is set to “invalid operator” (Step S309; Yes), the CPU 11 instructs the display unit 15 to display the warning notice indicating the contents for the invalid operator, in the direction which is matched with the direction of the invalid operator (Step S310). Then, the process shown in FIG. 15 is ended (End). The warning notice may be displayed so as to straddle a plurality of areas into which the display surface S is divided, as shown in FIG. 12, or may be displayed in the area in which the invalid operation is received.

In case that the operator to be noticed is not set to “invalid operator” (in case that the operator to be noticed is set to the main operator) (Step S309; No), the CPU 11 instructs the display unit 15 to display the warning notice in the same direction as the separate window which is displayed in the area in which the touch operation is received (Step S311). Then, the process shown in FIG. 15 is ended (End).

As described above, the embodiment is explained by using the drawings. However, in the present invention, the concrete configuration is not limited to the above embodiment. In the present invention, various modifications of the above embodiment or the addition of various functions or the like to the embodiment can be carried out without departing from the gist of the invention.

In the embodiment, the direction of the operator who carries out the touch operation is detected in accordance with the shape of the finger with which the touch operation is carried out. However, the direction of the operator may be detected by another method. For example, a sensor for detecting the operator's hand stretching to the display surface S, is provided on the peripheral end of the main body of the operation display device 10 or the like. By detecting the direction in which the operator's hand with which the touch operation is carried out is stretched from the periphery of the main body, the position of the operator who carries out the touch operation is recognized. Then, the relative direction of the operator, which is a direction relative to the display surface S may be judged. Further, the operators who exist around the display surface S may be shot by a small-sized camera and by analyzing the obtained image, the direction of the operator who carries out the touch operation may be judged.

The contents and the display form of the warning notice, which are shown in the embodiment, are just examples. In the present invention, the contents and the display form of the warning notice are not limited to the above example.

The specific operations which are listed in the embodiment, are just examples. Also, in case that another operator carries out an operation except the listed specific operations, the operation may be invalidated. Further, all of the operations carried out by another operator may be invalidated.

The number of the areas into the display surface S is divided may be fixed to 2, or may correspond to the number of the touch operations which are simultaneously detected (according to the circumstances, the number is not less than 3).

In the embodiment, the multi function peripheral 30 is remotely controlled by using the operation display device 10. However, the apparatus to be remotely controlled by the operation display device 10 may be another apparatus. The image processing apparatus having the operation display device is not limited to the multi function peripheral described in the embodiment, and may be an optional image processing apparatus, such as a copy machine, a facsimile apparatus, an image editing apparatus or the like.

One of the objects of the above embodiment is to provide an operation display device, an operation display method and a tangible computer-readable recording medium which can prohibit the touch operation which is the specific operation carried out by another user except the main operator, even though a plurality of persons view the display contents and commonly use the operation display device.

In the embodiment, in case that the touch operation which is received from the operator is the predetermined specific operation (for example, the operation for entering the security information, the operation for starting the execution of the job, or the like), and that the direction of the operator who carries out the touch operation is different from the direction of the window which is currently displayed, the touch operation is invalidated. That is, the specific operation which is carried out by another operation who does not view the window from the correct direction is invalidated.

In the embodiment, the operation display device detects the relative direction of the operator who carries out the touch operation with the finger, which is relative to the display surface, in accordance with the shape of the contact portion of the finger, which contacts to the display surface.

In the embodiment, the operation display device informs that the invalid touch operation is received from another user.

In the embodiment, because the operation for entering the security information, the operation for setting the transmission destination and the operation for starting the execution of the job are the important operation, the operation carried out by another operator who does not view the window from the correct direction is invalidated.

In the embodiment, when the touch operations carried out by two operators are simultaneously detected, the operation display device divides the display surface into two areas, displays the separate windows in two areas, respectively, and receives an operation the independently in each separate window.

In the embodiment, the direction of the separate window displayed in each area after dividing the display surface is preferentially matched with the direction of the operator who carries out the touch operation assigned to the corresponding area.

In the embodiment, the separate window having the display contents which are the same as those of the window displayed before dividing the display surface, is displayed in each area after dividing the display surface. Further, the size of the entry button in the separate window displayed in each area after dividing the display surface is not smaller than the size of the entry button in the window displayed before dividing the display surface. Therefore, after dividing the display surface, the operability of the entry button can be secured like the entry button in the window displayed before dividing the display surface.

According to the operation display device, the operation display method and the tangible computer-readable medium, it is possible to prohibit the touch operation which is the specific operation carried out by another user except the main operator, even though a plurality of persons view the display contents and commonly use the operation display device.

The present U.S. patent application claims the priority of Japanese Patent Application No. 2012-153854, filed on Jul. 9, 2012, according to the Paris Convention, and the entirety of which is incorporated herein by reference for correction of incorrect translation.

What is claimed is:

1. An operation display device, comprising:
a display unit;
a touch panel to detect a touch operation which is carried out to a display surface of the display unit;
a detecting unit to detect a relative direction of an operator who carries out the touch operation to the display surface of the display unit, the relative direction being a direction relative to the display surface;
a control unit to control display contents of the display unit,
wherein in case that the touch operation detected by the touch panel is a specific operation and that a direction of a window which is currently displayed by the display unit is not matched with the detected relative direction of the operator who carries out the touch operation, the control unit invalidates the touch operation.

2. The operation display device of claim 1, wherein the detecting unit detects the relative direction of the operator who carries out the touch operation with a finger, in accordance with a shape of a contact portion of the finger, which contacts to the display surface.

3. The operation display device of claim 1, wherein when the control unit invalidates the touch operation detected by the touch panel, the control unit carries out a predetermined warning notice.

4. The operation display device of claim 3, wherein the predetermined warning notice indicates contents for the operator by whom the window which is currently displayed by the display unit is viewed from a correct direction, and is displayed in a direction which is the same as the direction of the window.

5. The operation display device of claim 3, wherein the predetermined warning notice indicates contents for the operator who carries out the invalidated touch operation, and is displayed in a correct direction from the operator who carries out the invalidated touch operation.

6. The operation display device of claim 1, wherein the specific operation is at least one of an operation for entering security information, an operation for setting a transmission destination and an operation for starting an execution of a job.

7. The operation display device of claim 2, wherein the control unit judges whether two touch operations which are received for the window which is currently displayed by the display unit, are carried out by one operator or not by comparing the shape of the contact portion of the finger relating to one of the two touch operations with the shape of the contact portion of the finger relating to the other of the two touch operations, and
in case that the control unit judges that the two touch operations are carried out by different operators, respectively, the control unit divides the display surface of the display unit into two areas, and instructs the display unit to display separate windows in the areas, respectively.

8. The operation display device of claim 7, wherein when the control unit divides the display surface into the areas, the control unit preferentially assigns each touch operation to the area including a touch position of the each touch operation, and sets a direction of the separate window displayed in each area to a direction which is matched with the direction of the operator who carries out the touch operation assigned to the each area.

9. The operation display device of claim 7, wherein after the control unit divides the display surface, the control unit instructs the display unit to display the separate window having display contents which are same as display contents of the window displayed by the display unit before dividing the display surface, in each area, and instructs the display unit to display an entry button in the separate window in each area so as not to be smaller than the entry button in the window displayed before dividing the display surface.

10. A tangible computer-readable recording medium storing a program, wherein the program causes an information processing device comprising a display unit; a touch panel to detect a touch operation which is carried out to a display surface of the display unit; and a detecting unit to detect a relative direction of an operator who carries out the touch operation to the display surface of the display unit, the relative direction being a direction relative to the display surface; to execute:
invalidating the touch operation in case that touch operation detected by the touch panel is a specific operation and that a direction of a window which is currently displayed by the display unit is not matched with the detected relative direction of the operator who carries out the touch operation.

11. The tangible computer-readable recording medium of claim 10, wherein the program causes the information processing device to detect the relative direction of the operator who carries out the touch operation with a finger, in accordance with a shape of a contact portion of the finger, which contacts to the display surface.

12. The tangible computer-readable recording medium of claim 10, wherein when the information processing device invalidates the touch operation detected by the touch panel, the program causes information processing device to carry out a predetermined warning notice.

13. The tangible computer-readable recording medium of claim 12, wherein the predetermined warning notice indicates contents for the operator by whom the window which is currently displayed by the display unit is viewed from a correct direction, and is displayed in a direction which is the same as the direction of the window.

14. The tangible computer-readable recording medium of claim 12, wherein the predetermined warning notice indicates contents for the operator who carries out the invalidated touch operation, and is displayed in a correct direction from the operator who carries out the invalidated touch operation.

15. The tangible computer-readable recording medium of claim 10, wherein the specific operation is at least one of an operation for entering security information, an operation for setting a transmission destination and an operation for starting an execution of a job.

16. The tangible computer-readable recording medium of claim 11, wherein the program causes the information processing device to judge whether two touch operations which are received for the window which is currently displayed by the display unit, are carried out by one operator or not by comparing the shape of the contact portion of the finger relating to one of the two touch operations with the shape of the contact portion of the finger relating to the other of the two touch operations, and
in case that the information processing device judges that the two touch operations are carried out by different operators, respectively, the program causes the information processing device to divide the display surface of the display unit into two areas, and instruct the display unit to display separate windows in the areas, respectively.

17. The tangible computer-readable recording medium of claim 16, wherein when the program causes the information processing device to divide the display surface into the areas, the program causes the information processing device to preferentially assign each touch operation to the area including a touch position of the each touch operation, and set a direction of the separate window displayed in each area to a direction which is matched with the direction of the operator who carries out the touch operation assigned to the each area.

18. The tangible computer-readable recording medium of claim 16, wherein after the information processing device divides the display surface, the program causes the information processing device to instruct the display unit to display the separate window having display contents which are same as display contents of the window displayed by the display unit before dividing the display surface, in each area, and instruct the display unit to display an enter button in the separate window in each area so as not to be smaller than the entry button in the window displayed before dividing the display surface.

19. An operation display method for controlling an information processing device comprising a display unit; a touch panel to detect a touch operation which is carried out to a display surface of the display unit; and a detecting unit to detect a relative direction of an operator who carries out the touch operation to the display surface of the display unit, the relative direction being a direction relative to the display surface; the method comprising:
invalidating the touch operation in case that touch operation detected by the touch panel is a specific operation and that a direction of a window which is currently displayed by the display unit is not matched with the detected relative direction of the operator who carries out the touch operation.

20. The operation display method of claim 19, wherein the relative direction of the operator who carries out the touch operation with a finger, is detected in accordance with a shape of a contact portion of the finger, which contacts to the display surface.
